(19) United States
(12) Patent Application Publication
(10) Pub. No.: US 2014/0371930 A1
(43) Pub. Date: Dec. 18, 2014

(54) ENERGY DISTRIBUTION NETWORK

(71) Applicant: Izudin Dzafic, Sarajevo (BA)

(72) Inventor: Izudin Dzafic, Sarajevo (BA)

(73) Assignee: SIEMENS AKTIENGESELLSCHAFT, MUENCHEN (DE)

(21) Appl. No.: 14/356,660

(22) PCT Filed: Nov. 7, 2011
(86) PCT No.: PCT/EP2011/069518

§ 371 Date: Aug. 26, 2014

(51) Int. Cl. H02J 3/00; G05B 15/02

(52) U.S. Cl. CPC H02J 3/006; G05B 15/02
USPC 700/286

(57) ABSTRACT

An energy distribution network has a first substation, which is able to supply a first sub-network and a second substation, which is able to supply a second sub-network. The first and second sub-networks are electrically linked to one another via at least one switch so that the first sub-network, or a subsection thereof, connected to the first substation, is alternatively connected to the second substation for supply with energy by the second substation. The second substation is configured such that in response to a request to supply energy to the first sub-network or a subsection thereof, which were previously supplied with energy by the first substation, it checks whether it has sufficient resources to supply the first sub-network or the subsection. If sufficient resources exist, it starts to supply energy to the first sub-network or the subsection.

The invention relates to an energy distribution network comprising a first substation, which is able to supply energy to a first subnet work of the energy distribution network, and a second substation, which is able to supply energy to a second subnet work of the energy distribution network.

Energy distribution networks today are usually monitored and controlled centrally. The centralized units conventionally used for monitoring and control require a multiplicity of data in order to ensure reliable operation of the energy distribution network. In the event of a fault, e.g. in the event of a short circuit on one of the lines of the energy distribution network, situations can occur in which manual intervention in the control of the energy distribution network is required by operating personnel in order to manage the fault that has occurred and ensure that the energy distribution network affected by the fault is in a reliable operating state. As a result of the multiplicity of data in the centralized unit, it cannot always be guaranteed that the operating personnel will make the right decisions and that the interventions performed by the operating personnel will have the desired success.

The object of the invention is therefore to specify an energy distribution network which allows reliable operation even in the event of a fault.

This object is achieved according to the invention by an energy distribution network having the features in claim 1. Advantageous embodiments of the energy distribution network according to the invention are specified in sub claims.

According to the invention, provision is made for the first and the second sub network to be electrically linked via at least one switch in such a manner that the first subnet work, or a subsection thereof, which is connected to the first substation is alternatively connected to the second substation and could be supplied with energy by said second substation, and the second substation is so designed that, in response to a request to supply energy to the first subnet work, or a subsection thereof, which was previously supplied with energy by the first substation, it checks whether the second substation has sufficient resources to supply the first subnet work or the subsection thereof and, if sufficient resources exist, starts to supply energy to the first subnet work or the subsection of the first subnet work.

It is considered an essential advantage of the energy distribution network according to the invention that it can reconfigure itself autonomously, e.g. in the event of a fault. By virtue of the substations according to the invention being capable of autonomously checking whether it would be possible to supply energy to subnet works of other substations or subsections of subnet works of other substations, and actually starting to supply energy to the external subnet works or the external subsections in response to a corresponding request if applicable, reconfiguration of the energy distribution network can be effected directly at substation level. Provision may also be made for incorporating a centralized unit, but this not essential in the energy distribution network according to the invention since the substations are able independently to check their resources for supplying subnet works or subsections and independently to perform a reconfiguration. The amount of data for transmission to a centralized unit and consequential further risk of error can also be reduced thus.

In order to allow the energy distribution network to be reconfigured as quickly as possible, provision is advantageously made for the first and the second substation each to have a communication device and be able to establish a communication connection to each other via said communication device, either directly or with the involvement of a supervisory centralized unit.

Direct data transfer between the substations is considered advantageous, however, since it increases the data transfer speed and allows intervention in the distribution of energy within the energy distribution network by components at substation level alone, i.e. without involvement of a supervisory centralized unit.

The data transmitted between the substations can also be transmitted to the supervisory centralized unit, in order that the currently active configuration of the energy distribution network can also be evaluated and if applicable controlled centrally.

With regard to the embodiment of the two substations, the first substation is advantageously so designed that, in the event of a supply shortage in the first subnet work, it sends a request (e.g. in the form of a request signal) to at least the second substation to assume responsibility for the supply of the first subnet work or a subsection thereof. The second substation is preferably so designed that, in response to the request from the first substation, it checks whether it has sufficient resources to supply the first subnet work or a subsection thereof.

With regard to the structure of the substations, it is considered advantageous when the substations comprise a communication device and an associated computing device in each case.

The computing device of the second substation is preferably programmed in such a way that, in response to the request from the first substation, it checks whether the second substation has sufficient resources to supply the first subnet work or a subsection thereof and, if sufficient resources exist, generates at least one control signal which triggers a switchover of the at least one switch and a supply of energy to the first subnet work or a subsection of the first subnet work. By virtue of the substations being able to reconfigure the energy distribution network independently, an optimal working speed can be achieved, e.g. in the event of a fault.

In order to allow and/or simplify checking of resources, provision is advantageously made for the substations, at least the second substation, to be so designed as to refer to loading and/or topology data, which is provided by the first substation or a centralized unit and relates to the first subnet work or its subsection, when checking whether sufficient resources are available to supply the first subnet work or its subsection.

The transfer of the loading and/or topology data to the second substation can take place e.g. automatically as soon as a corresponding request for the additional energy supply is sent to the second substation. Provision can alternatively be made for the second substation, following receipt of a prompt for the additional energy supply, autonomously to retrieve loading and/or topology data itself from either the first substation, which sent the relevant request, and/or from the centralized unit where the relevant loading and/or topology data may also be present.

When transferring the loading and/or topology data, provision can be made for sending the second substation only such data as relates to the subsection which must now be supplied. Alternatively, current loading and/or topology data of the entire first subnet work or current loading and/or topology data of the entire energy distribution network can also be transferred to the second substation.

Depending on the workload of the second substation, the situation can arise in which the second substation itself does not have sufficient resources to supply energy to the first subnet work or a subsection thereof as per the request. In order that the energy distribution network can continue to operate reliably in such an event, provision is advantageously made for the second substation and in particular its computing device to be capable of disconnecting the second subnet work or a subsection of this second subnet work which it previously supplied, thereby making available resources by means of which the energy supply to the first subnet work or a subsection of the first subnet work can be provided.

In order nonetheless to allow a continued energy supply in the event that the second subnet work or a subsection of the second subnet work is disconnected, provision is advantageously made for the second subnet work and a third subnet work, which is supplied with energy by a third substation, to be electrically linked via at least one further switch in such a manner that the second subnet work, or a subsection thereof, which is connected to the second substation can alternatively be connected to the third substation and supplied with energy by said third substation. The second substation is preferably capable, before or after disconnecting the second subnet work or a subsection of this second subnet work supplied by said second substation, of generating a request signal and sending said signal via its communication device to at least the third substation, by means of which signal another substation, in particular the third substation, is requested to supply energy to the second subnet work or a subsection of this second subnet work.

All substations of the energy distribution network are preferably capable, as a first, second or third substation within the meaning of the description given above, of generating requests or request signals, evaluating loading and/or topology data, and participating in a reconfiguration of the energy distribution network.

In summary, the substations of the energy distribution network described above can autonomously bring about a redistribution of the energy flow within the energy distribution network in the event of a fault, specifically by disconnecting or switching over subsections or subnet works of the energy distribution network, thereby in many cases achieving a continuous energy distribution even in the event of a fault.

The invention further relates to a substation for an energy distribution network as described above. According to the invention, provision is made for the substation to be so designed that, in response to a request to supply energy to a subnet work, or a subsection thereof, which was previously supplied by a different substation, it independently checks whether sufficient resources are available to supply this subnet work or this subsection and, if sufficient resources exist, starts to supply energy to this subnet work or this subsection.

With regard to the advantages of the substation according to the invention, reference is made to the advantages cited above in respect of the energy distribution network according to the invention, since the advantages of the energy distribution network according to the invention essentially correspond to those of the substation according to the invention.

With regard to the structure of the substation, provision is advantageously made for the substation to have a communication device via which it can establish a communication connection with other substations.

The substation preferably has a computing device which is connected to its communication device and programmed in such a way that, in response to the request from another substation, it checks whether sufficient resources are available to supply the subnet work or the subsection and, if sufficient resources exist, generates at least one control signal which triggers a switchover of at least one switch and therefore a supply of energy to this subnet work or this subsection.

The invention moreover relates to a method for operating an energy distribution network, in which a first substation supplies energy to a first subnet work of the energy distribution network and a second substation supplies energy to a second subnet work of the energy distribution network. According to the invention, provision is made in such a method for the first and the second subnet work to be isolated from each other by at least one switch in the absence of any faults; in the event of a supply shortage of the first subnet work or a subsection thereof, the first substation generates a prompt signal by means of which other substations of the energy distribution network, in particular at least the second substation, are requested henceforth to supply energy to the first subnet work, or a subsection thereof, which was previously supplied by the first substation; and the second substation checks whether sufficient resources are available to supply the first subnet work or a subsection of the first subnet work and, if sufficient resources exist, the second substation connects the first and the second subnet work to each other via the at least one switch and starts to supply energy to the first subnet work or a subsection of the first subnet work.

With regard to the advantages of the method according to the invention, reference is made to the explanations given above in respect of the energy distribution network according to the invention, since the advantages of the energy distribution network according to the invention essentially correspond to those of the substation according to the invention.

According to a preferred embodiment of the method, provision is made for the second substation to receive loading and/or topology data from the first substation or a centralized unit, said data relating to the first subnet work, or its subsection, which is henceforth to be supplied by the second substation instead of by the first substation. The second substation preferably refers to this loading and/or topology data when checking whether sufficient resources are available to supply the first subnet work or its subsection.

The substations are preferably first-level substations, i.e. local network stations.

The invention is explained in greater detail below with reference to exemplary embodiments in which:

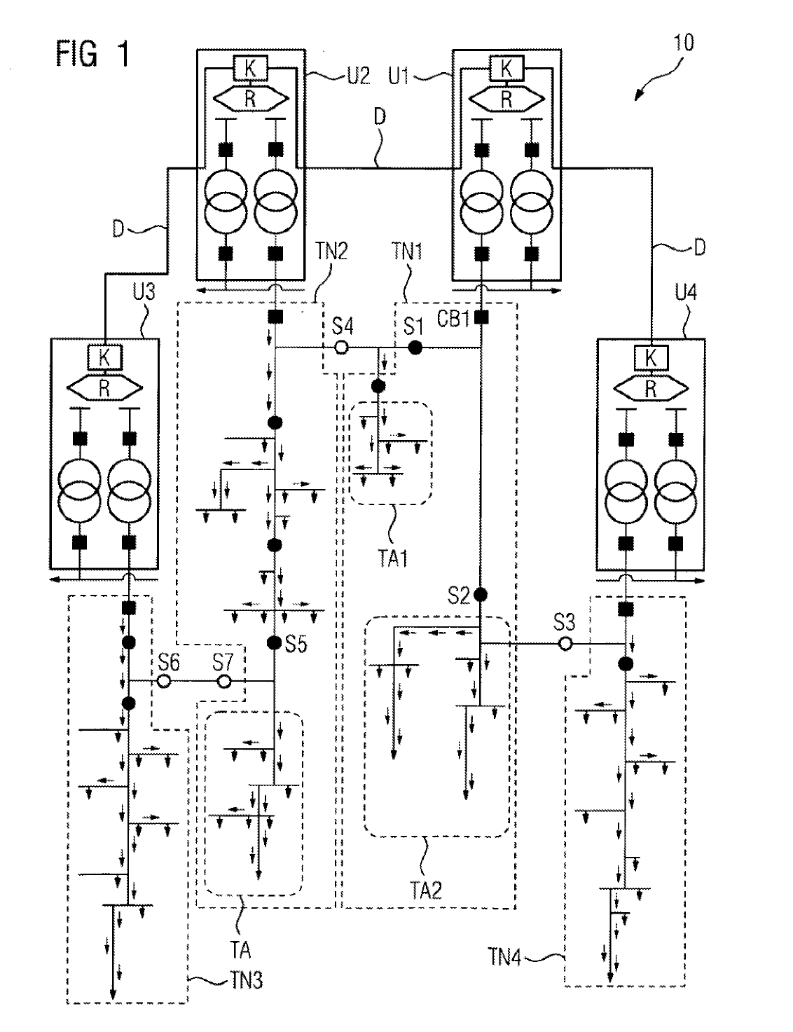

FIGS. 1-8 show an exemplary embodiment of an energy distribution network according to the invention, the method according to the invention being explained by way of example with reference to said embodiment, and

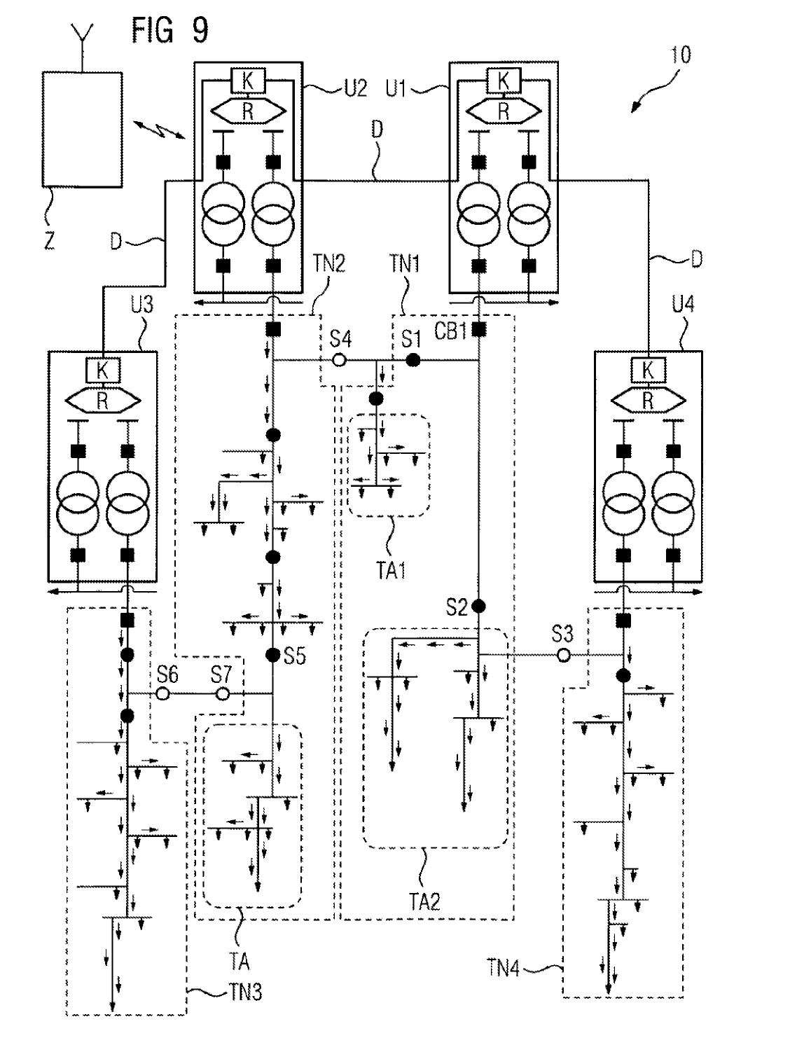

FIG. 9 shows a further exemplary embodiment of an energy distribution network according to the invention.

For the sake of clarity, identical or comparable components are denoted by the same reference signs in each case.

FIG. 1 shows an energy distribution network 10, of which four subnet works TN1, TN2, TN3 and TN4 are illustrated in FIG. 1.

The first subnet work TN1 is supplied with electrical energy by a substation U1 and has a first subsection TA1 and a second subsection TA2. The two subsections TA1 and TA2 of the first subnet work TN1 are electrically connected to the substation U1 via activated switches CB1, S1 and S2. As a result of the three switches CB1, S1 and S2 being in an activated state (illustrated by black circles or squares in the figures), energy from the substation U1 can flow to both subsections TA1 and TA2 and/or energy can be taken from the subsections by the substation U1.

The subnet works TN2, TN3 and TN4 are connected to the substations U2, U3 and U4 correspondingly, and can be supplied with energy via these. The subnet works TN2, TN3 and TN4 or their subsections are connected to each other inter alia via switches S3, S4, S5, S6 and S7. In the figures, these switches are shown to be in a closed switch state by means of black circles and an open switch state by means of white circles.

The four substations U1, U2, U3 and U4 each have a communication device K which allows direct communication with other substations. Connected to the communication devices K in each case is a computing device R which is programmed in such a way that it can perform the substation functions described below.

The four substations U1, U2, U3 and U4 are connected to each other via data lines D, such that they can exchange data with each other directly via these data lines D.

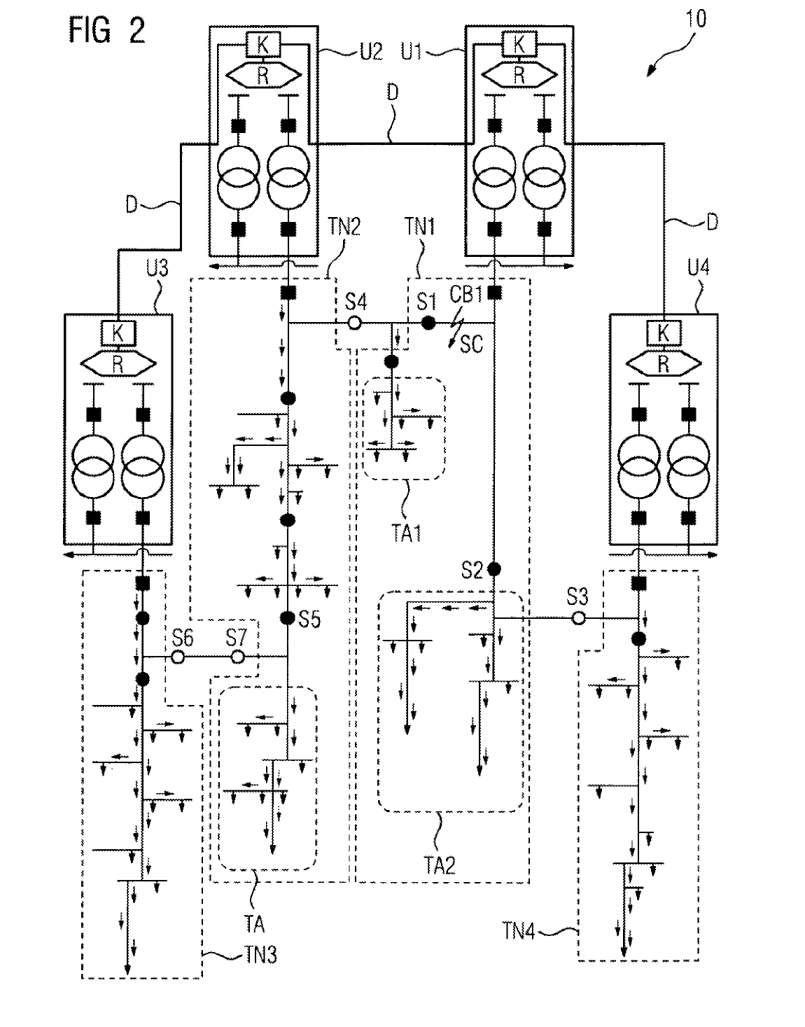

The operation of the energy distribution network 10 is now explained in greater detail with reference to an exemplary embodiment. In this case, it is assumed by way of example that an electrical short circuit occurs in that section of the first subnet work TN1 which is electrically delimited by the switches CB1, S1 and S2. This short circuit is symbolized in FIG. 2 by an arrow having the reference sign SC.

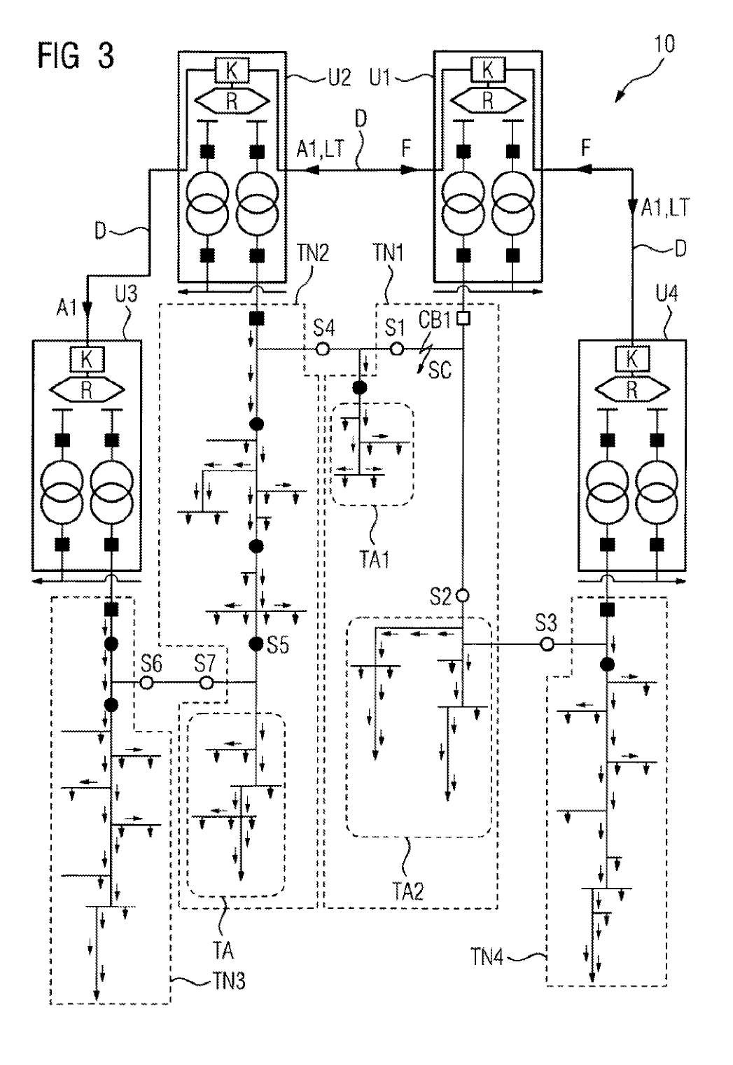

As soon as the substation U1 establishes that an electrical short circuit has occurred in the first subnet work TN1, it opens the three switches S1, S2 and CB1 in order to isolate the defective section of the first subnet work TN1 from the network. This operating state is illustrated in FIG. 3. It can be seen that, as a result of switching off these three switches S1, S2 and CB1, both the first subsection TA1 and the second subsection TA2 are isolated from the network and can therefore no longer be supplied with energy by the substation U1.

In order to solve this problem, the substation U1 transmits a prompt signal to all other substations, i.e. including the second substation U2 and the fourth substation U4 inter alia, requesting a supply of energy to the first subnet work TN1 or the subsections TA1 and TA2. The prompt signal is denoted by the reference sign A1 in FIG. 3.

As soon as the other substations, being the substations U2, U3 and U4 in FIG. 3, receive the prompt signal A1, they check whether it is possible to supply energy to the first subnet work TN1, which is affected by the fault. In order to perform this check, the substations U2, U3 and U4 require the current loading and topology data LT of the first subnet work TN1 and of the two subsections TA1 and TA2. This loading and topology data LT can be transmitted automatically when the first substation U1 generates its prompt signal Al and sends it to the other substations U2, U3 and U4. For example, the loading and topology data can be sent from the first substation U1 directly to the other substations. Alternatively, the loading and topology data can be transmitted to the substations by a centralized unit which is not shown in FIG. 1.

Instead of the loading and topology data LT being transferred automatically, the substations can also become active independently and, upon receipt of the prompt signal A1, send a corresponding request signal F to the first substation U1 or a centralized unit, requesting the transmission of the loading and topology data LT (see FIG. 3). By way of example in FIG. 3, it is assumed that both of the substations U2 and U4 request and receive the loading and topology data LT from the substation U1.

As soon as the loading and topology data LT of the first subnet work TN1 is received by the fourth substation U4, the substation U4 autonomously checks whether it could supply energy to all of the first subnet work TN1 or a section thereof. For this purpose, it determines the totality of resources available to the fourth substation U4, either from energy generation within the subnet work TN4 or from an external supply, and the proportion of these resources already being consumed in the fourth subnet work TN4.

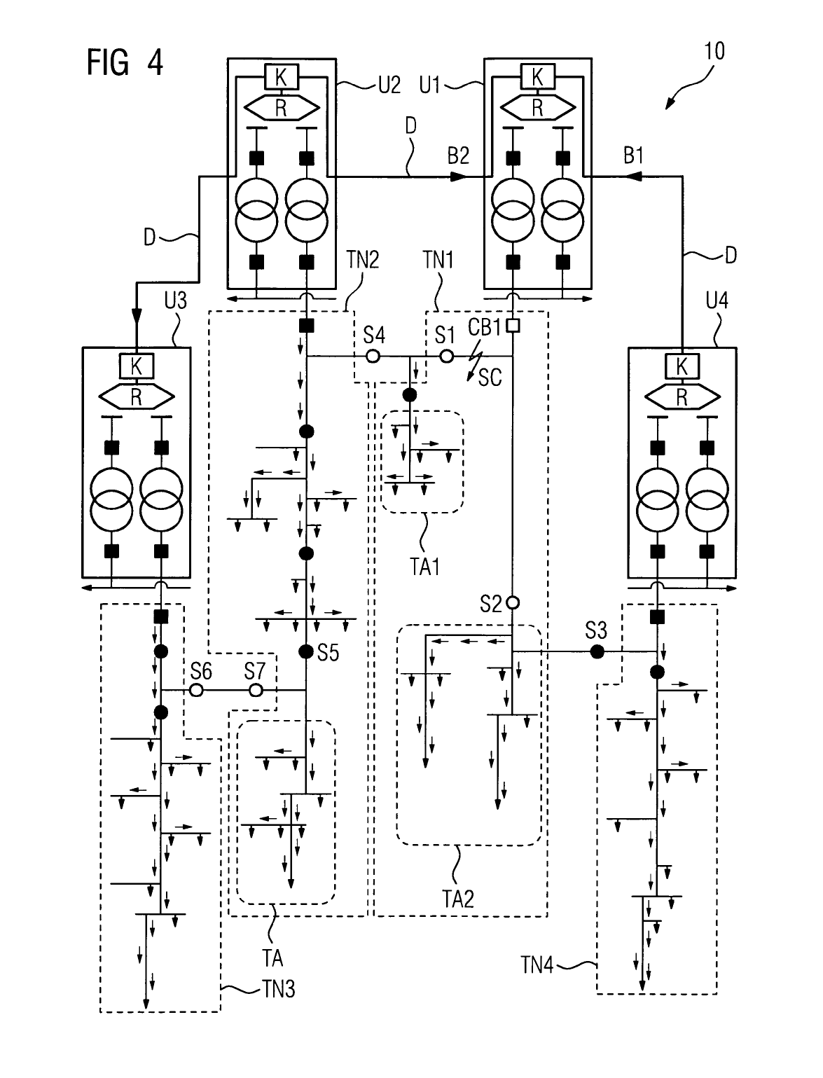

If for example the fourth substation U4 establishes that it can supply energy to the second subsection TA2 of the first subnet work TN1, it notifies the first substation U1 accordingly by means of a confirmation signal B1 and generates a control signal by means of which the switch S3 connecting the two subnet works TN1 and TN4 to each other is closed. This state of the energy distribution network 10 is illustrated in FIG. 4. As a result of activating the third switch S3, an energy supply to the second subsection TA2 of the first subnet work TN1 is therefore effected by the fourth substation U4. In other words, the second subsection TA2 of the originally first subnet work TN1 is therefore appended to the fourth subnet work TN4.

The corresponding reconfiguration of the energy distribution network 10 resulting from the activation of the switch S3 can also be transmitted to a centralized unit by the fourth substation U4, e.g. by also sending the confirmation signal B1 to the centralized unit.

With regard to the second substation U2, it is now assumed by way of example that after receiving the prompt signal A1, said second substation U2 determined upon checking its resources that there is no possibility of it assuming responsibility for the energy supply of the entire first subnet work TN1 or even one of the subsections TA1 or TA2 owing to a lack of sufficient resources locally. The second substation U2 can transmit this result to the first substation U1 by means of e.g. a confirmation signal B2 via the data line D (see FIG. 4).

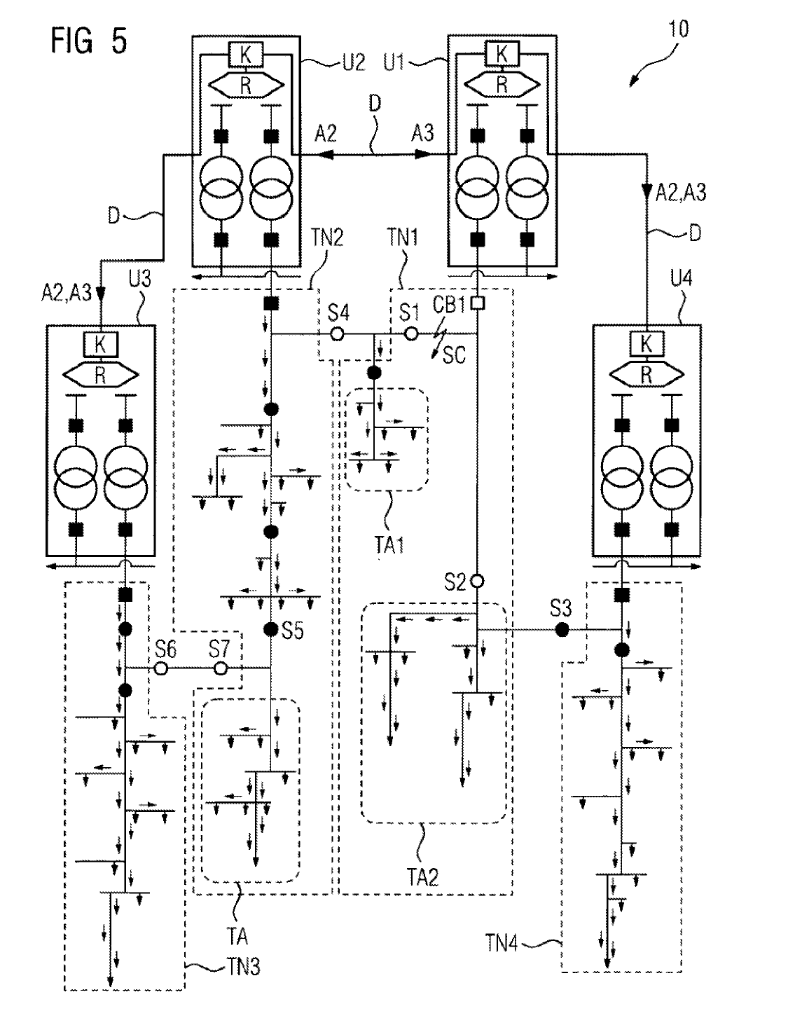

The substation U1 now has the information that the second subsection TA2 of the first subnet work TN1 is supplied with energy, specifically by the fourth substation U4, and that the first subsection TA1 is still cut off from an energy supply. On this basis, the first substation U1 then generates a further prompt signal A2 and transmits to all substations, requesting that responsibility be assumed for supplying energy to the first subsection TA1 (see FIG. 5).

Following receipt of the second prompt signal A2, and on the basis of the previously received loading and topology data, the second substation U2 has the information that a supply to the first subsection TA1 can only be effected by the second substation U2 if the switch S4 is closed. In order to allow a switchover of the switch S4 and a subsequent supply of energy to the first subsection TA1, the second substation U2 must economize resources. Such an economy of resources would be possible in the second subnet work TN2 if a subsection TA were to be disconnected and instead supplied with energy by a different substation, e.g. the third substation U3. In order to effect such a switchover of the subsection TA, the second substation U2 generates a prompt signal A3, which it sends to all substations and therefore also to the third substation U3 (see FIG. 5).

Following receipt of the third prompt signal A3, and on the basis of current loading and topology data LT2 which relates solely to or at least also to the subsection TA of the second subnet work TN2, the third substation U3 checks whether it has sufficient resources to supply energy to this subsection TA of the second subnet work TN2.

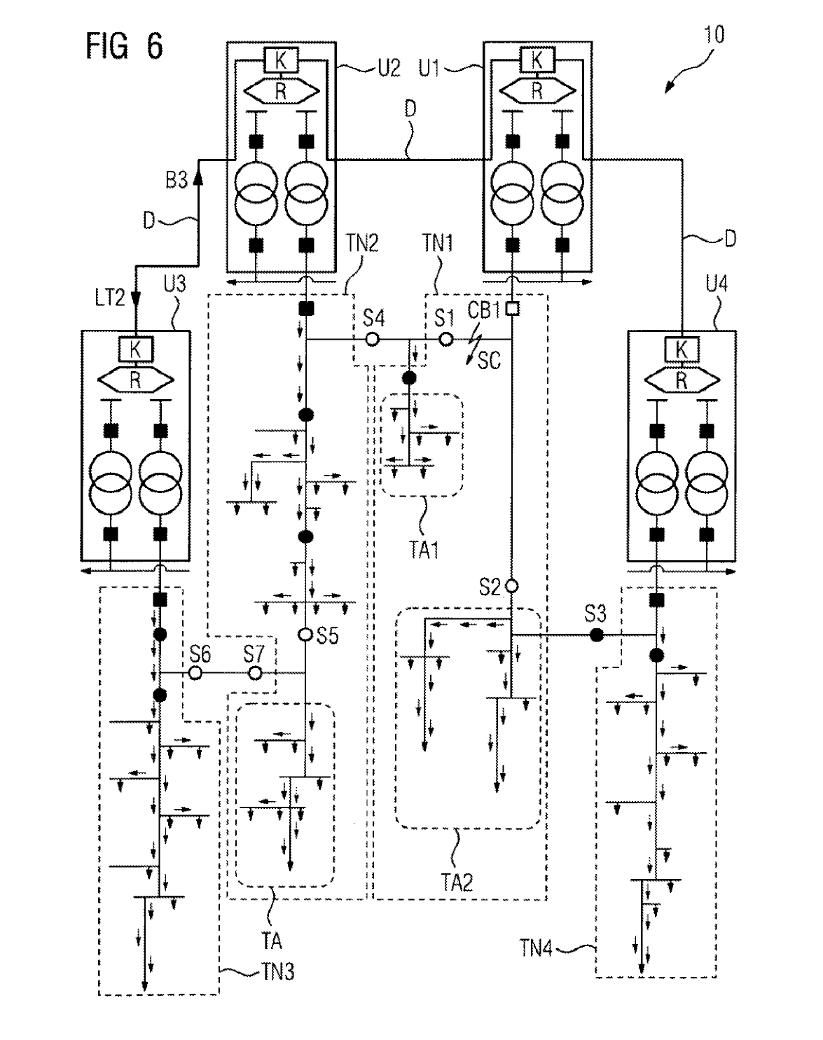

It is now assumed by way of example that the third substation U3 concludes that is would be possible to supply energy to the subsection TA of the second subnet work TN2. In this case, the third substation U3 generates a confirmation signal B3 by means of which it confirms that it assumes responsibility for supplying energy to the subsection TA (see FIG. 6).

Following receipt of the confirmation signal B3, the second substation U2 opens the switch S5 by means of a corresponding control instruction, such that the subsection TA is electrically isolated from the second substation U2 (see FIG. 6).

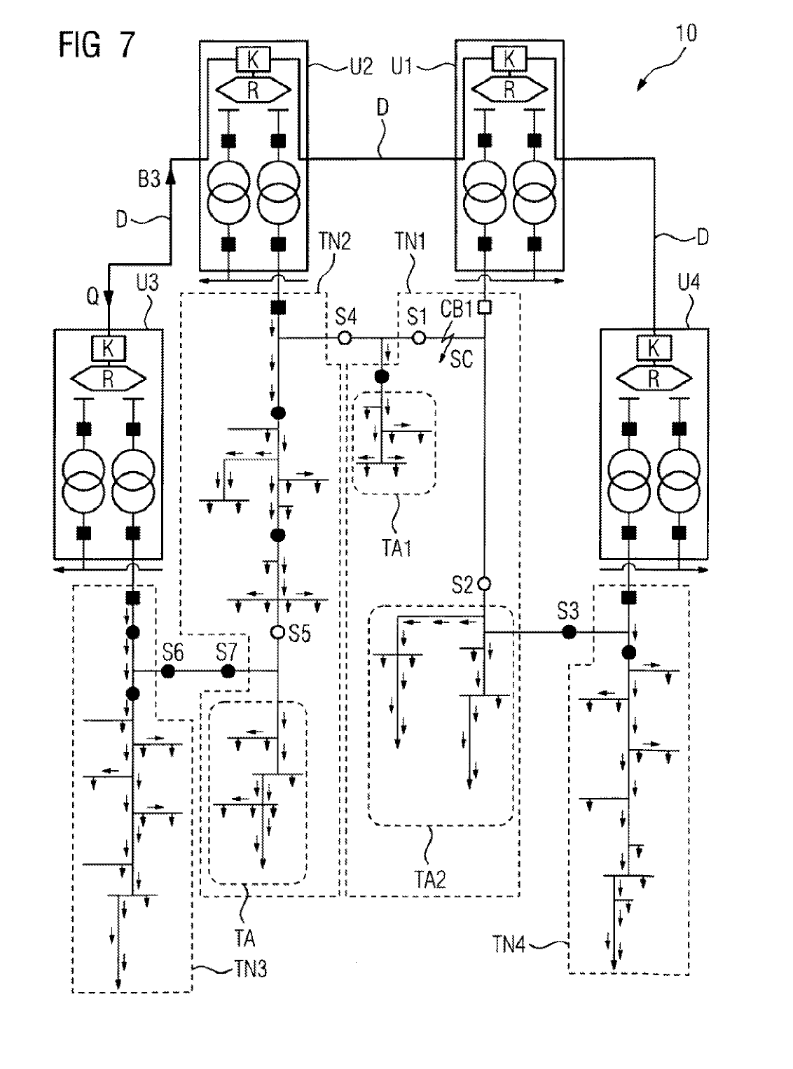

Following receipt of a corresponding acknowledgment signal Q from the second substation U2 or after expiry of a specified time period, the third substation U3 generates control signals by means of which the switches S6 and S7 are activated, such that the subsection TA is connected to the third subnet work TN3. Following the activation of the switches S6 and S7 (see FIG. 7), the subsection TA is supplied by the third substation U3 and is therefore effectively part of the third subnet work TN3.

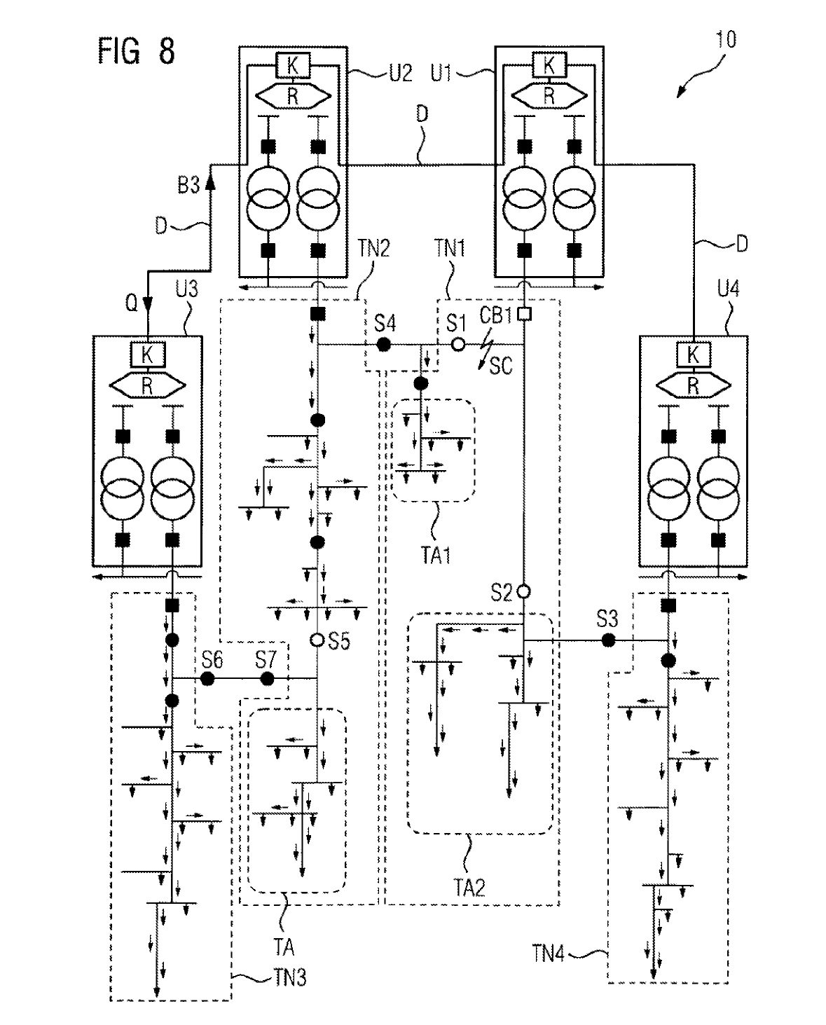

Finally, the substation U2 closes the switch S4 in order to connect the first subsection TA1 of the subnet work TN1 to the substation U2 (see FIG. 8).

In summary, the energy distribution network 10 as per the FIGS. 1 to 8 has substations U1 to U4, which can communicate directly with each other and, by virtue of the way they are embodied and in particular the embodiment and the programming of their computing devices R, are able autonomously to reconfigure the energy distribution network 10 in order to allow a continued supply, even in the event of a fault, of those subsections affected by the fault.

According to the exemplary embodiment as per the FIGS. 1 to 8, and as explained above, as a result of the autonomous reconfiguration of the network the subsections TA1 and TA2 are no longer supplied by the first substation U1 after the occurrence of a fault, but are instead supplied by the two substations U2 and U4 jointly, wherein the third substation U3 assumes responsibility for a subsection TA of the second subnet work TN2 in order to support the substation U2.

According to the exemplary embodiment as per the FIGS. 1 to 8, the reconfiguration of the energy distribution network 10 is effected exclusively at the level of the substations. No involvement of a centralized unit is required in this exemplary embodiment.

FIG. 9 shows an exemplary embodiment of an energy distribution network 10 in which the substations U1 to U4 are also connected to a centralized unit Z, either via data lines D or wirelessly.

The reconfiguration of the energy distribution network 10 as per FIG. 9 can be effected as described in detail with reference to the exemplary embodiment as per the FIGS. 1 to 8, i.e. exclusively at the level of the substations. In addition, provision can be made for the prompt signals and confirmation signals resulting in a reconfiguration of the energy distribution network 10 to also be transmitted to the centralized unit Z, in order to ensure that said centralized unit Z is notified of the respective operating state of the energy distribution network 10 at all times.

It is also possible for the loading and topology data LT and LT2 to be transmitted from the centralized unit Z to the substations U1 to U4 if the latter send corresponding prompt signals to the centralized unit Z. Retrieval of the loading and topology data LT from the centralized unit Z advantageously reduces the load on the substations U1 to U4.

Although the invention has been illustrated and described in detail with reference to preferred exemplary embodiments, the invention is not restricted by these examples, and other variations can be derived there from by a person skilled in the art without thereby departing from the scope of the invention.

### LIST OF REFERENCE SIGNS

10 Energy distribution network
A1,A2,A3 Prompt signal
F Request signal
B1,B2,B3 Confirmation signal
CB1,S1-S7 Switch
D Data line
K Communication device
LT, LT2 Loading and topology data
Q Acknowledgment signal
R Computing device
TA,TA1,TA2 Subsections
TN1-TN4 Subnet works
U1-U4 Substations
Z Centralized unit

1-10. (canceled)

11. An energy distribution network, comprising:
a first substation connected to, and configured to supply energy to, a first sub-network of the energy distribution network;
a second substation connected to, and configured to supply energy to, a second sub-network of the energy distribution network;
said first and second sub-networks being electrically linked via at least one switch enabling said first sub-network, or a subsection thereof, to be alternatively connected to said second substation and to be supplied with energy by said second substation;
said second substation being configured, upon receiving a request to supply energy to said first sub-network, or a subsection thereof, that were previously supplied with energy by said first substation, to check whether said second substation has sufficient resources to supply said first sub-network or the subsection thereof and, if sufficient resources exist, to start supplying energy to said first sub-network or the subsection of said first sub-network.

12. The energy distribution network according to claim 11, wherein:
each of said first substation and said second substation has a communication device configured to establish a communication connection to each other via said communication device;
said first substation is configured, in the event of a supply shortage in said first sub-network, to send a request to at least said second substation to assume responsibility for supplying said first sub-network or a subsection thereof; and
said second substation is configured, in response to a request from said first substation, to check whether sufficient resources are available to supply said first sub-network or the subsection thereof.

13. The energy distribution network according to claim 12, wherein said second substation has a computing device connected to said communication device thereof and programmed, in response to the request from said first substation, to check whether said second substation has sufficient resources to supply said first sub-network or the subsection thereof and, if sufficient resources exist, to generate at least one control signal for triggering a switchover of said at least one switch and a supply of energy to said first sub-network or the subsection of said first sub-network

14. The energy distribution network according to claim 11, wherein said second substation is configured, when checking whether sufficient resources are available to supply said first sub-network or the subsection thereof, to refer to data selected from the group consisting of load data and topology data provided by said first substation or by a centralized unit and related to said first sub-network or the subsection.

15. The energy distribution network according to claim 11, wherein said second substation is configured for disconnecting said second sub-network or a subsection of said second sub-network which it previously supplied, to thereby make available resources for supplying energy to said first sub-network or a subsection of said first sub-network.

16. The energy distribution network according to claim 13, wherein said computing device of said second substation is programmed for disconnecting said second sub-network or a subsection of said second sub-network from the energy supply in order to thereby make available resources for supplying energy to said first sub-network or a subsection of said first sub-network.

17. The energy distribution network according to claim 15, which further comprises a third sub-network and a third substation for supplying energy to said third sub-network, and wherein:
said second sub-network and said third sub-network are electrically linked via at least one further switch enabled to alternatively connect said second sub-network, or a subsection thereof, to said third substation to be supplied with energy by said third substation; and
said second substation is configured, before or after disconnecting said second sub-network or the subsection of said second sub-network supplied by said second substations, to generate a prompt signal and to send the prompt signal via its communication device to at least said third substation, the prompt signal requesting said third substation o supply energy to said second sub-network or a subsection of said second sub-network.

18. In an energy distribution network having sub-networks each supplied with energy by a respective substation connected thereto and being electrically linked via at least one switch enabling a first sub-network, or a subsection thereof, to be alternatively connected to a second substation and to be supplied with energy by the second substation, a substation for the energy distribution network, wherein:
the substation is configured, in response to a request to supply energy to a given sub-network, or a subsection thereof, which was previously supplied by a different substation, to independently check whether sufficient resources are available to supply the sub-network or the subsection and, if sufficient resources exist, to start supplying energy to the sub-network or the subsection thereof.

19. The substation according to claim 18, further comprising a communication device for establishing a communication connection to the other substation, and a computing device connected to said communication device and programmed, in response to the request from another substation, to check whether sufficient resources are available to supply the sub-network or the subsection and, if sufficient resources exist, to generate a control signal triggering a switchover of at least one switch and therefore a supply of energy to the sub-network or the subsection.

20. A method of operating an energy distribution network wherein a first substation supplies energy to a first sub-network of the energy distribution network and a second substation supplies energy to a second sub-network of the energy distribution network (10), the method comprising:
isolating the first and second sub-networks from each other by at least one switch in the absence of a fault;
in the event of a supply shortage of the first sub-network or a subsection thereof, generating at the first substation a prompt signal for requesting another substation of the energy distribution network henceforth to supply energy to the first sub-network, or a subsection thereof, which was previously supplied by the first substation;
checking, with the other substation, whether sufficient resources are available to supply the first sub-network or the subsection of the first sub-network; and
if sufficient resources exist, connecting with the second substation the first and the second sub-network to each other via the at least one switch and starting to supply energy to the first sub-network or a subsection of the first sub-network.

21. The method according to claim 20, wherein the first substation generates the prompt signal for the second substation to henceforth supply energy to the first sub-network or the subsection, and wherein the second substation checks whether sufficient resources are available.

22. The method according to claim 21, which comprises receiving at the second substation load data and/or topology data from the first substation or from a centralized unit, the load data and/or topology data relating to the first sub-network, or its subsection, which is henceforth to be supplied by the second substation instead of by the first substation, and wherein the second substation refers to the load data and/or topology data when checking whether sufficient resources are available to supply the first sub-network or its subsection.
